(19) United States
(12) Patent Application Publication
(10) Pub. No.: US 2004/0127340 A1
(43) Pub. Date: Jul. 1, 2004

(54) Process for the manufacture of an easy open device for flow pack or similar packages with longitudinal seams, opening device obtained by said process, and package using it

(75) Inventor: Francisco Parra, Buenos Aires (AR)

Correspondence Address: FINNEGAN, HENDERSON, FARABOW, GARRETT & DUNNER, LLP, 1300 I STREET, NW, WASHINGTON, DC, 20005, US

(73) Assignee: Celomat Etiquetas Especiales S.A.

(21) Appl. No.: 10/669,699

(22) Filed: Sep. 25, 2003

Related U.S. Application Data
(62) Division of application No. 10/006,695, filed on Dec. 10, 2001.

(51) Int. Cl. B31B 1/78

(52) U.S. Cl. 493/309

(57) ABSTRACT

Process for the manufacture of an easy open device for “Flow Pack” or similar packages with longitudinal seams and transversal closings, structured horizontally or vertically, with a detachable strip, attached in alignment on the internal face of the packaging film by means of an applicator head, to be manually grasped and to result in the tearing of said packages, including the steps of:

attaching said strip transversally with respect to the machine direction and to the internal face of the packaging film, and

producing a cut on at least one end of said detachable strip to generate a tear area

An easy open device for packages produced with the process and packages produced with it are also being disclosed.

The present invention relates to a process for the manufacture of an easy open device for “Flow Pack” or similar packages with longitudinal seams and transversal closures, an opening device obtained through said process, and the package using it.

More specifically, it relates to a process for placing a detaching or easy open strip in packages with longitudinal seams and transversal closures [in] which, because of their current manufacturing characteristics, said opening is made by tearing, with the risk of spillage of the packaged product and subsequent destruction of the package. It could be said that package manufacturing techniques are divided into packages with and without longitudinal seams and transversal closures. The first are the so-called “Flow Pack” packages and the second are the so-called “portfolio” and/or wrapper packages.

Portfolio-type packages are produced by the movement in the machine direction of the already-printed packaging film, said printing generally being readable in the direction perpendicular to the film's movement. The product to be packaged arrives at the film perpendicularly to its movement, supported by disks on both ends. At the same time, a detaching or easy open strip is incorporated longitudinally into said film by an applicator head. The detaching strip comes on a spool. While continuously unwinding, it is fixed with adhesive to the internal face of the packaging film in an area near one end of the product to be packaged. Said strip is not longer than the width of the package, generally not exceeding 15 cm, and one of its ends is exposed by lateral incisions to allow for manual detachment so the packaged product can be accessed.

These types of machines have cylinders that adjust the area where said detachable strip will be placed, but their degree of precision is relative, so there is generally displacement which affects the proper operation of said strip. Also, during the process of constructing the package, the free end for tearing said strip may not match up with the circumference it should describe. Consequently, when it does not close over itself, the tear is not clean. In some cases, said strip is not even where it should be. As indicated, once the package is constructed with its detachment strip incorporated, one frangible end is left free to open it. This free end, not attached to the rest of the package, is made with at least one cut in one side of the strip. If

there are two cuts to both sides, they may not be symmetrical because of synchronization problems, which makes a neat opening even more difficult to achieve. If this occurs, more force must be applied than that required for opening, which distorts it and entails high risk for the product and package integrity.

This type of package uses heat activated adhesive to seal the ends, because of which the product to be consumed can also be damaged, due to the pressure of the disks and the temperature applied, as in the case of packets of crackers, in which the first and last are generally damaged.

The undesired effects that may accompany the wrapping or portfolio technique, plus their hermetic closure, motivated the appearance and the increasingly frequent use of “FlowPack” type packages which, because of their transversal packaging characteristic, could not, until now, have an easy open device. There are two types of Flow Pack packages, those generated horizontally and those generated vertically, also called sacks.

In horizontal packaging, the product is positioned on the printed film which will make up the package in [a] direction parallel to the readable printing, because of which it must enter parallel to the machine direction, which means

perpendicular with respect to the aforementioned packages that are produced longitudinally (or “portfolio”). The film closes over itself on one face of the package, producing a longitudinal fold or seam which is heat sealed. The same occurs on the ends. Due to the manufacturing characteristics of this type of package, the application of a detaching strip which is continuous and in the machine direction, as in the case of longitudinally-manufactured packages, involves several difficulties, such as:

It would use a longer strip, with the consequent higher cost

It would interfere with the heat seal areas, making [the sealing] difficult, acting as a potential contamination factor.

It would expose the entire packaged product without the ability to be re-closed, with the consequent product deterioration.

In the case of vertical or sack type “Flow Pack” packages (filled gravimetrically or volumetrically), the process is different because it is not continuous. Its intermittent nature is due to the fact that one end of the package must be sealed and the longitudinal seam must be generated so that, when gravity causes the product to fall, it is confined in the package. Subsequently, the other end (where the product enters) is sealed, thus generating the base for the next package. The inclusion of a detaching strip has also not been used because of the problems previously set forth with respect to the conventional processes for inserting said strips.

Therefore, and in keeping with what has been set forth, at this time, there are no known processes for including detaching (also known as “easy open”) strips in packages with longitudinal seams and transversal closures, commonly known as “Flow Pack.”

Based on what has been set forth, the need to develop a process for the manufacture of an easy opening for these types of packages is clear, since at the current time they are opened only by tearing one of the ends or through the longitudinal seam (which can be located anywhere on the package). In the majority of cases, this causes spillage of the product because of the force needed to break the heat seal and, in some cases, destruction of the package.

Another as yet unresolved problem is reclosing the packages after opening. Generally, once the packages are opened, they are closed with a rubber band, a clasp, a clip, or any other prehensile implement. It is well known that in food products with a high fat content, rapid oxidation occurs, producing the so-called “sogginess” (and possible sticking in the package), destroying crispness and freshness. In the case of Flow Pack packages, this difficulty increases because, as in the majority of cases, the package is in very poor condition after being manually opened and it is very difficult to reconstruct it to close it by any of the means mentioned. So there is a need to open these packages in a non-traumatic manner and then close them so they keep the packaged products fresh.

Another difficulty arises in the case of promotions or economy packs of any kind that include more of a product at the same time. In the case of wanting to package, for example, three packets of crackers for a promotion, double packaging is necessary. First, each product individually, and then grouping them in a single package, either with a wrapping film of sealed polyethylene or in a closed box. This is so because the difficulties mentioned with respect to the destruction

of the packages with longitudinal seams are aggravated even more in this case, since, if there were no individual packages inside the collective package, many products would be exposed, and, in the event of its destruction by tearing, significant spillage would result. Also, the cost of this double packaging is so high that, in the majority of cases, promotions do not achieve their expectations or objectives.

Therefore, the purpose of using the present invention is to provide a process for inserting a detaching or “easy open” strip in Flow Pack or similar packages with longitudinal seams and transversal closures, manufactured horizontally or vertically.

Another purpose is that said detaching strip be easy to detach.

Still another purpose is that the opening procedure not endanger the integrity of the package.

Yet another purpose is that the process for including a detaching strip not increase costs.

After purpose is to provide an easy closure for packages with longitudinal seams and transversal closures.

The invention will be better understood with reference to the drawings, in which:

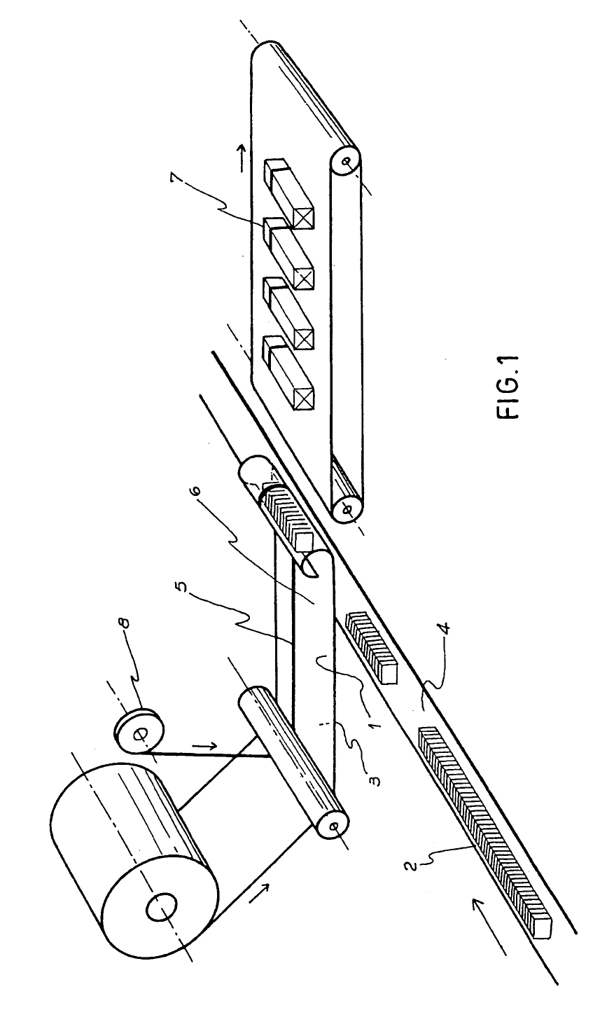

FIG. 1 shows a longitudinal packaging or wrapping machine.

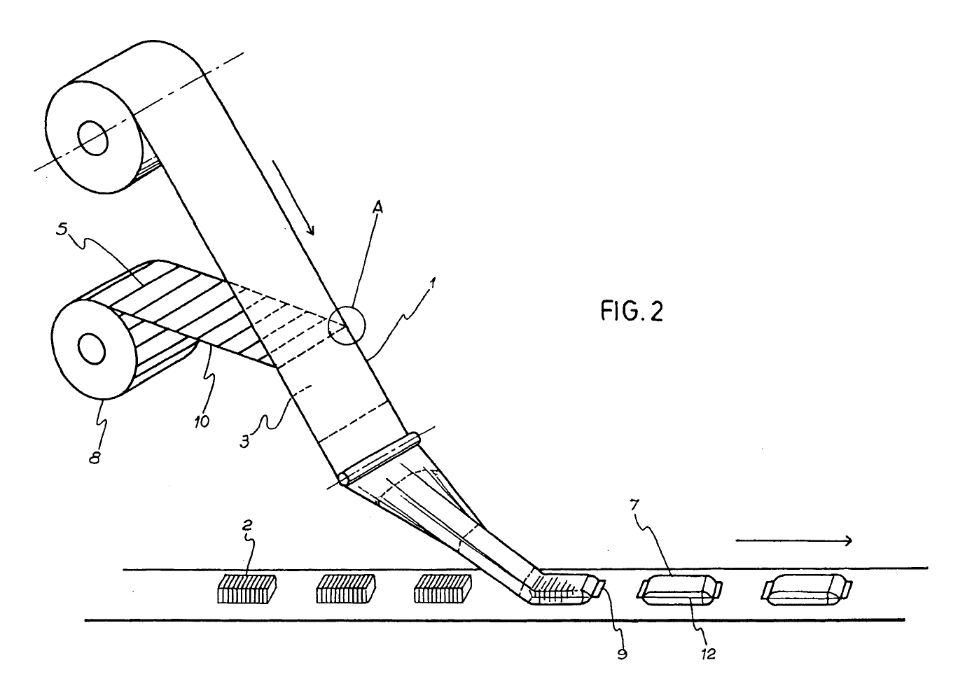

FIG. 2 shows a horizontal Flow Pack packaging machine with the inclusion of the purpose of the present invention.

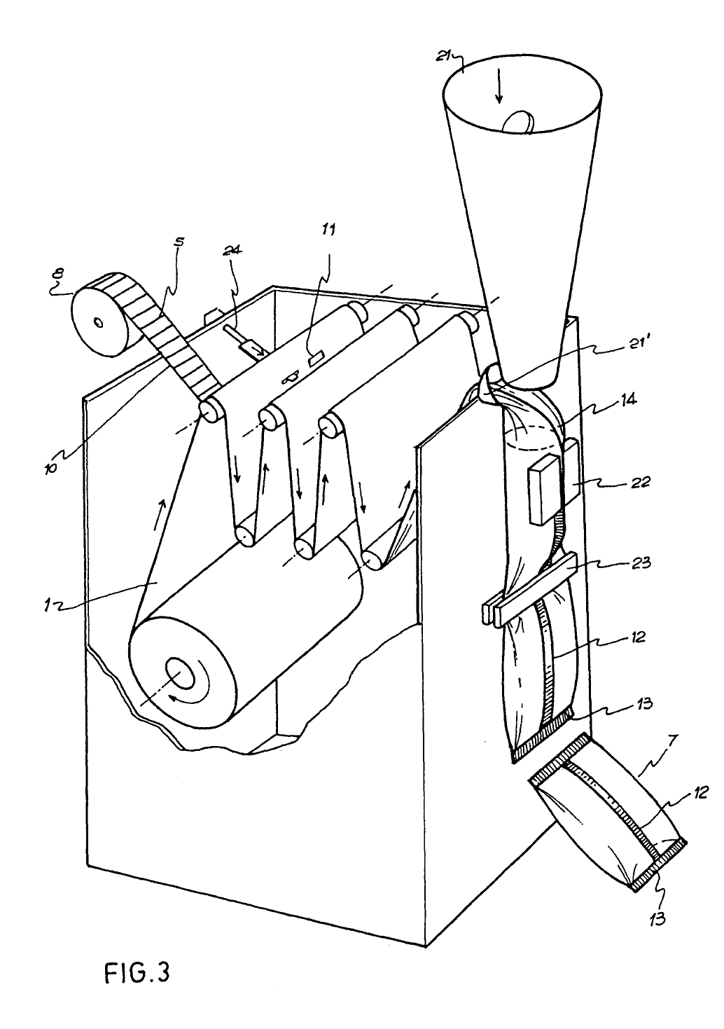

FIG. 3 shows a vertical or sack type Flow Pack packaging machine with the inclusion of the object of the present invention.

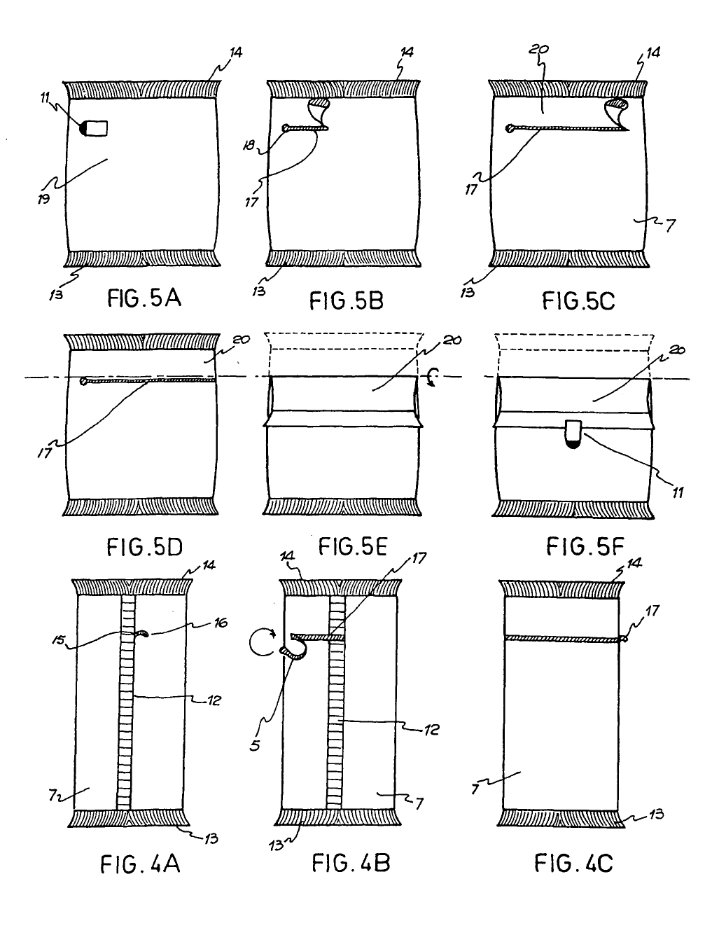

FIGS. 4A to C show an easy open sequence with the free end of the detaching strip located on the longitudinal seam of the Flow Pack packages.

FIGS. 5A to F show an easy open and closing sequence when the end of the detaching strip is not placed on the longitudinal seam of the Flow Pack packages.

### DETAILED DESCRIPTION OF THE INVENTION

As can be seen in FIG. 1, referring to longitudinal (wrapping or portfolio) packaging machines, the packaging film (1) on which the product to be packaged is deposited (2) is moved, with printed face (3) down and readable perpendicularly to the machine direction. The product to be packaged enters through one side on a conveyor belt (4) perpendicularly to the machine direction, as indicated by the arrows. This process incorporates a detachable strip (5), which is attached to the internal (unprinted) face (6) of the packaging film (1). This detachable strip is continuously unwinding from the spool (8) so that, after the final cut, it will surround the entire perimeter of the package (7). Its final length is, in the majority of cases, not greater than 15 cm. This, of course, depends on the product to be packaged.

FIG. 2 shows how horizontal Flow Pack packages are produced. The packaging film (1) is moved, with printed face (3) up and generally readable, parallel to the machine direction, as indicated by the arrows. At a certain point, the product (2) to be packaged is incorporated in the machine direction. Then the packaging film (1) is folded, wrapping the product (2), and a longitudinal seam (12) is generated. This seam is preferably located in the center of the package, which is heat- or cold-sealed. The same occurs with the ends of the package (9), which are pressed, heat- or cold-sealed, and cut. In this way the process keeps mechanical elements from coming into contact with the product (2) to be consumed and jeopardizing its integrity. If the process included a spool (8) containing a strip (5Y, such as the one described in FIG. 1, which is unwound continuously and whose detaching strip (5) is attached to the internal face of the package (3), an undesired opening area that would expose all of the product would be generated; it would also have to span areas that are sealed, which could result in product (2) deterioration.

FIG. 2 shows a spool (8) with a rolled plastic siliconed carrier or liner (10) that has detaching strips (5) not longer than the width of the packaging film (1), which is the object of the present invention. Said strip (5) has adhesive on its printed face; this process is called “occluded printing.” The ink is occluded because of the requirement to not expose the printed face to the package contents (7).

The siliconed carrier (10) is punched and, using an applicator head (not

shown in the figure), the detaching strips (5) are applied to the internal face of the packaging film (1) continuously, accurately aligned.

Said strips (5) must be thick and rigid enough so that, once the cut is initiated, the subsequent release of the material accompanies their detachment.

As indicated, these detaching strips (5) are placed along the width of the siliconed carrier (10) that supports them. This means that they will be deposited transversally with respect to the machine direction and perpendicular to the readable printing on the packaging film (1). The release area (17 FIGS. 5 and 6) can be generated on just one face of the package (7) or on all of them (with total detachment of the portion of the package above said strip). The fact that the release area (17. FIGS. 5 and 6) is not the total perimeter of the package (7) makes it possible to use an easy open/close element (11 FIGS. 3 and 5) that enables said package (7) to be closed for subsequent use, thus preserving the product to be consumed. This easy open/close element (11 FIGS. 3 and 5) can either be affixed to one face of said package (7) or inside said package (7) as a self-sticking label.

Said detachable strip (5) can be positioned on any part of the package (7). Everything will depend on the type of product to be consumed. In the case of disposable tissues, it could be inserted in the middle of the package (7), but in the case of crackers, a position near one of the ends (9) would be suitable. Application is made with a standard aligning applicator head known in the art which, through the optical reading of a reference element on the packaging film (1) (not provided in the figure); indicates where said detachable strip (5) should be affixed.

Optical alignment is much more accurate than mechanical devices in relation to the aforementioned problem of displacement, with which the associated problems regarding release are also solved. The place where said strip (5) is to be affixed is previously input manually in the production line control logic (PLC), which in turn transmits the information entered to the optical reader, which activates the applicator head when said strip (5) must be affixed to the packaging film (1).

FIG. 3 shows a packaging machine for vertical Flow Pack packages, also called sacks (7). Gravity plays an important role in this process. The film (1) moves vertically (see arrow), producing first a package (7) with a longitudinal seam (12) generated by means of longitudinal clamps (22), a sealed lower end (13) generated by means of transversal clamps (23), and an upper end (14) originally opened by means of a shaping shoulder (21). Through it enters the product to be packaged, which is gravimetrically or volumetrically measured out through the hopper (21). The subsequent heat sealing of said upper end (14) by action of the transversal clamps (23) shapes the lower end (13) of the next sack, and so on. This process is not continuous, since it is necessary to wait for the package (7) to be filled in order to move on to the next. The purpose of the present invention is to participate in the packaging process through the previously-described spool (8), which has a siliconed carrier or plastic liner (10) that supports the detaching strips (5), which, by means of an applicator head (not shown in the figure), are affixed transversally to the packaging sheet (1) and aligned with a through cut (18) generated by the first cutting machine (24). Then the easy open/close element (11) is attached, also aligned and on the area of said cut (18), by means of another applicator head (also not shown).

FIGS. 4A to C show an example of [the] opening sequence for the Flow Pack packages from the longitudinal seam. There are two small incisions (15) in said seam (12) where one of the ends (16) of the detaching strip (5) is located for easy grasping and to generate the release area (17) since, as is well known, said longitudinal seam (12) is not attached to the package (7) and moves freely. It could be made a requirement that the detaching strip (5) be located on the face that is not affected by the seam (12) or it could be required that the desired length of the strip not touch the seam; this example will be described in the next Figure.

When one end of the detaching strip (5) is not positioned on the seam (12) and, therefore, cannot be easily grasped except after ripping, it becomes vital to include an element to facilitate that task (FIGS. 5A to F). Said element should be directly attached to that end of the detaching strip (5) and to the area of the through cut (18) to generate the release area (17). Part of this element's surface should be self-sticking to establish that connection, and the rest of this element's surface should be non-sticking so it can be easily grasped, as occurred in the case of the free end (16) of the detaching strip (5) described in FIG. 4A. This aforementioned easy open/close (11) element will be described below.

As can be seen in the sequence of FIGS. 5A to F, for the best preservation of the products which a package (7) contains, an easy open/close element (11) could be used on one of its faces (19) with the part of the surface that is attached blocking said through cut area (FIG. 5B reference 18) and one end of the detaching strip (5). The other part of the surface of said easy open/close element (11) does not contain adhesive, so it can be easily grasped by the end user (FIG. 5A) and can begin the release area (17). When said release area (17) (FIG. 5B) is begun, it extends to one side of the package 7 (FIG. 5C), in turn generating an upper flap (20). When the opening of the package (7) (FIG. 5D) is complete, said upper flap (20) folds over itself (SE) and over the release area (17) and then adheres to one of the faces of the package (7) (FIG. 5F) using said easy open/close element (11) previously detached from the detaching strip (5).

Finally, the affixing of the detaching strips (5) to the internal face of the film (3) of the package (7) may be accomplished on line in real time via a spool (8) that is unrolled as the packages (7) are constructed, or off line, in which case the packaging film (1) is ready to be incorporated after the packaging process with the strips (5) included. This latter case involves unrolling the entire spool (8), affixing the strips (5) at intervals controlled by optical and/or mechanical reading,

and ultimately rewinding said spool (8).

Although the present invention has been described according to a specific implementation method, all persons skilled in the art will understand that various changes can be made and that equivalents can be substituted without departing from the true scope and spirit of the invention. In addition, many modifications can be made to adapt a situation, a material, a combination of materials, one or more specific steps of the process, to the purpose, the spirit, or the scope of the present invention. The purpose of all these modifications is inclusion in the scope of the claims attached hereto.

1. Process for the manufacture of an easy open device for “Flow Pack” or similar packages with longitudinal seams and transversal closings, constructed horizontally or vertically, with a detachable strip, attached and aligned on the internal face of the packaging film by means of an applicator head, to be manually grasped and to result in the tearing of said packages, which includes the steps of:
attaching said strip transversally to the machine direction on the internal face of the packaging film, and
producing a cut on at least one end of said detachable strip to generate a tear area.

2. Process according to claim 1, wherein said tear area generates an upper flap between said tear area and said closest transversal closure.

3. Process according to claim 1, wherein said cut is accomplished by means of at least one incision parallel to the detaching strip and on the longitudinal seam.

4. Process according to claim 1, wherein said cut is accomplished by means of a through cut on one end of the detaching strip, both being attached to an easy open/close element that blocks said through cut and said end of said detaching strip.

5. Process according to claim 4, wherein the part of the surface of said easy open/close element which blocks said through cut and said end of said detaching strip is self-sticking and reclosable.

6. Process according to claim 4, wherein the part of the surface that can be grasped by the consumer of said easy open/close element contains no adhesive.

7. Process according to claims 2 and 4, wherein said upper flap is folded over on itself and over the tear area, attaching to one of the faces of said package across the self-stick part of the surface of said easy open/close element (to produce its closure).

8. Process according to claim 1, wherein said detachable strip is affixed to the packaging film off the package production line.

9. Process according to claim 1, wherein said detachable strip is affixed to the packaging film on the package production line.

10. Process according to claim 1, wherein said aligned attachment on the internal face of said package includes the steps of:
inputting the position of said detaching strip on said package in the control logic,
optically reading the alignment for said packaging film in motion,
transmitting the information to said applicator head regarding said detaching strip,
detaching, by means of said applicator head, said detaching strip from said siliconed material that supports it,
affixing, by means of said applicator head, said detaching strip to said internal face of said packaging film.

11. Easy open device for “Flow Pack” or similar packages with longitudinal seams and transversal closures, with at least two faces, one frontal and the other posterior, constructed horizontally or vertically, possessing a detaching strip with one of its faces printed, obtained through the process referred to in claim 1, wherein on the internal face of at least one of said faces of said package there is attached, transversally to the machine direction, said detaching strip being not longer than the width of the package, which in turn defines a tear area on said package.

12. Easy open device according to claim 11, wherein said printed face of said detaching strip (occluded printing) is fixed with adhesive to said internal face of said packaging film.

13. Easy open device according to claim 11, wherein said detaching strip has one of its ends located on said longitudinal seam on which at least one incision is made parallel to said detaching strip (to facilitate the tearing of the packaging film).

14. Easy open device according to claim 11, wherein said detaching strip has at least one of its ends positioned in an area where there is a through cut and, both being attached in turn to an easy open/close element that blocks said through cut and said end of said detaching strip (to facilitate tearing of said detaching strip).

15. Easy open device according to claim 11, wherein said tear area creates an upper flap between said tear area and said nearest transversal closure.

16. Easy open device according to claims 14 and 15, wherein said upper flap folds over on itself and over the tear area, attaching to one face of said package across the self-stick part of the surface of said easy open/close element (to
produce its closure).

17. Packages that have longitudinal seams and transversal closures, constructed horizontally or vertically, wherein they have the easy open device referred to in clauses 11 to 16.
